(19) United States
(12) Patent Application Publication
(10) Pub. No.: US 2024/0023191 A1
(43) Pub. Date: Jan. 18, 2024

(54) METHOD AND APPARATUS FOR MULTICAST AND BROADCAST SERVICES

(71) Applicant: Lenovo (Beijing) Limited, Beijing (CN)

(72) Inventors: Mingzeng Dai, Shanghai (CN); Joachim Löhr, Wiesbaden (DE); Lianhai Wu, Beijing (CN); Congchi Zhang, Shanghai (CN); Hyung-Nam Choi, Ottobrunn (DE); Le Yan, Shanghai (CN); Prateek Basu Mallick, Dreieich (DE)

(73) Assignee: Lenovo (Beijing) Limited, Beijing (CN)

(21) Appl. No.: 18/256,192

(22) PCT Filed: Dec. 15, 2020
(86) PCT No.: PCT/CN2020/136501

§ 371 Date: Jun. 6, 2023

(51) Int. Cl. H04W 76/27; H04W 76/40

(52) U.S. Cl. CPC H04W 76/27; H04W 76/40

(57) ABSTRACT

Embodiments of the present application relate to a method and apparatus for multicast and broadcast services (MBS). An exemplary method can include: receiving configuration information indicating: receiving configuration information indicating a first data inactivity timer associated with MBS; and determining whether to transfer from a first radio resource control (RRC) state to a second RRC state at least based on the first data inactivity timer. Embodiments of the present application can avoid unnecessary RRC state transition of a user equipment (UE).

### TECHNICAL FIELD

Embodiments of the present application generally relate to wireless communication technology, especially to a method and apparatus for multicast and broadcast services (MBS).

### BACKGROUND

In new radio (NR), the work item on NR support of MBS was agreed in R17 (e.g., RP-201038), wherein all radio resource control (RRC) states, i.e., RRC_IDLE state, RRC_INACTIVE state and RRC_CONNECTED state will be supported in MBS according to the following objectives of the work item description (WID): 1) specify radio access network (RAN) basic functions for broadcast/multicast for user equipment (UEs) in RRC_CONNECTED state; and 2) specify RAN basic functions for broadcast/multicast for UEs in RRC_IDLE/RRC_INACTIVE state.

In addition, in RAN2 #112e meeting, RAN2 agreed the following two modes for NR MBS delivery: 1) one delivery mode with high quality of service (QoS) (e.g., reliability, latency, and so on) requirement to be available in RRC_CONNECTED state; and 2) one delivery mode with low QoS requirement, where a UE can also receive data in RRC_IDLE/RRC_INACTIVE state.

However, when a UE is configured with a MBS session with high QoS requirement, how to avoid the UE moving to RRC_IDLE state or RRC_INACTIVE state unnecessarily has not been discussed yet.

Thus, an improved technical solution for MBS to avoid unnecessary RRC state transition should be seriously considered.

### SUMMARY OF THE APPLICATION

Some embodiments of the present application at least provide a technical solution for multicast and broadcast services.

According to some embodiments of the present application, a method may include: receiving configuration information indicating a first data inactivity timer associated with MBS; and determining whether to transfer from a first RRC state to a second RRC state at least based on the first data inactivity timer.

In some embodiments, the method may further include: in the case of receiving or transmitting data on at least one logical channel of a set of logical channels in the first RRC state being RRC_CONNECTED state, starting or restarting the first data inactivity timer; and in the case that the first data inactivity timer expires, transferring to the second RRC state being RRC_IDLE state or RRC_INACTIVE state from the first RRC state.

In an embodiment, the set of logical channels may include at least one of: a multicast traffic channel (MTCH), and a multicast control channel (MCCH).

In another embodiment, the set of logical channels may include a subset of a set of MBS logical channels, and the set of MBS logical channels may include: a MTCH of a delivery mode with high QoS requirement, a MCCH of a delivery mode with high QoS requirement, a MTCH of a delivery mode with low QoS requirement, and a MCCH of a delivery mode with low QoS requirement. High QoS requirement and low QoS requirement are different for different service types, and persons skilled in the art could clearly determine the high QoS requirement and low QoS requirement in different application scenarios. For example, the high QoS requirement may mean high reliability, low latency, and etc. The low QoS requirement may means low reliability, high latency, and etc.

In yet another embodiment, the subset of the set of MBS logical channels may include at least one of: the MTCH of a delivery mode with high QoS requirement, and the MCCH of a delivery mode with high QoS requirement.

In yet another embodiment, the set of logical channels may include a subset of a set of MBS logical channels, and the set of MBS logical channels may include: a traffic channel for a multicast session, a control channel for a multicast session, a traffic channel for a broadcast session, and a control channel for a broadcast session.

In yet another embodiment, the subset of the set of MBS logical channel may include at least one of: the traffic channel for a multicast session, and the control channel for a multicast session.

In some other embodiments, the configuration information may further indicate a second data inactivity timer associated with unicast services, and the method may include: in the case of receiving or transmitting data on at least one MBS logical channel in the first RRC state being RRC_CONNECTED state, starting or restarting the first data inactivity timer; in the case of receiving or transmitting data on at least one unicast logical channel, starting or restarting the second data inactivity timer; and in the case that both the first data inactivity timer and the second data inactivity timer expire, transferring to the second RRC state being RRC_IDLE state or RRC_INACTIVE state from the first RRC state.

In an embodiment, the at least one MBS logical channel is at least one of a MTCH and a MCCH, or at least one of a MTCH of a delivery mode with high QoS requirement and a MCCH of a delivery mode with high QoS requirement, or at least one of a traffic channel for a multicast session and a control channel for a multicast session; and the at least one unicast logical channel is at least one of a common control channel (CCCH), a dedicated control channel (DCCH); and a dedicated traffic channel (DTCH).

In some other embodiments, the method may further include: deactivating or suspending the first data inactivity timer in response to one of the followings: performing a MBS session join procedure for at least one MBS session, or for at least one MBS session of a delivery mode with high QoS requirement, or for a multicast session; receiving a MBS session configuration for at least one MBS session, or for at least one MBS session of a delivery mode with high QoS requirement, or for a multicast session; and performing a MBS session start procedure for at least one MBS session, or for at least one MBS session of a delivery mode with high QoS requirement, or for a multicast session.

In some other embodiments, the method may further include: activating or resuming the first data inactivity timer in response to one of the followings: performing a MBS session leave procedure for all MBS sessions, or for all MBS sessions of a delivery mode with high QoS requirement, or for all multicast sessions; and performing a MBS session stop procedure for all MBS sessions, or for all MBS sessions of a delivery mode with high QoS requirement, or for all multicast sessions.

In some other embodiments, the method may further include: deactivating or suspending the first data inactivity timer in response to a received signalling indicating one of the followings: a data inactivity monitoring indication, a timer deactivation indication, and a timer suspension command.

In some other embodiments, the method may further include: activating or resuming the first data inactivity timer in response to a received signalling indicating one of the following: a data inactivity monitoring indication, a timer activation indication; and a timer resumption command.

In an embodiment, the received signalling is one of the following: a RRC signaling, a medium access control (MAC) control element (CE), and downlink control information (DCI) in a physical downlink control channel (PDCCH).

In some other embodiments, the method may further include: in the case that the first data inactivity timer expires, transmitting a first indication to indicate the expiry of the first data inactivity timer in the first RRC state being RRC_CONNECTED; and receiving a second indication indicating whether to transfer from the first RRC state to the second RRC state being RRC_IDLE state or RRC_INACTIVE state.

In some other embodiments, the method may further include: in the case that the first data inactivity timer expires and there is available MBS context for a MBS session or available MBS context for a MBS session of a delivery mode with high QoS requirement or available MBS context for a multicast session, transmitting the first indication to indicate the expiry of the first data inactivity timer.

In some other embodiments, the configuration information indicates that the first data inactivity timer has a value of “infinite.”

In some other embodiments, the method may further include: setting a value of the first data inactivity timer to be “infinite” in response to one of the followings: performing a MBS session join procedure for at least one MBS session, or for at least one MBS session of a delivery mode with high QoS requirement, or for a multicast session; receiving a MBS session configuration for at least one MBS session, or for at least one MBS session of a delivery mode with high QoS requirement, or for a multicast session; and performing a MBS session start procedure for at least one MBS session, or for at least one MBS session of a delivery mode with high QoS requirement, or for a multicast session.

According to some other embodiments of the present application, a method may include: setting a first inactivity timer associated with MBS for a UE; monitoring a data transmission state on a set of sessions associated with the UE in a first RRC state; and determining whether to indicate the UE to transfer from a first RRC state to a second RRC state based on the first inactivity timer and the monitoring.

In some embodiments, the method may further include: in the case that the first inactivity timer expires: indicating the UE to transfer from the first RRC state being RRC_CONNECTED state to the second RRC state being RRC_IDLE state or RRC_INACTIVE state; and indicating an MBS related UE inactivity to a core network.

In some other embodiments, the method may further include: setting a second inactivity timer associated with unicast sessions for the UE; and in the case that both the first inactivity timer and the second inactivity timer expire: indicating the UE to transfer from the first RRC state being RRC_CONNECTED state to the second RRC state being RRC_IDLE state or RRC_INACTIVE state; and indicating an MBS related UE inactivity to a core network.

In some other embodiments, the method may further include: deactivating or suspending the first inactivity timer in response to one of the followings: performing a MBS session join procedure for at least one MBS session, or for at least one MBS session of a delivery mode with high QoS requirement, or for a multicast session; transmitting a MBS session configuration for at least one MBS session, or for at least one MBS session of a delivery mode with high QoS requirement, or for a multicast session; and performing a MBS session start procedure for at least one MBS session, or for at least one MBS session of a delivery mode with high QoS requirement, or for a multicast session.

In some other embodiments, the method may further include: activating or resuming the first inactivity timer in response to one of the following: performing a MBS session leave procedure for all MBS sessions, or for all MBS sessions of a delivery mode with high QoS requirement, or for all multicast sessions; and performing a MBS session stop procedure for all MBS sessions for all MBS sessions, or for all MBS sessions of a delivery mode with high QoS requirement, or for all multicast sessions.

In some other embodiments, a value of the first inactivity timer is set to be “infinite.”

In some other embodiments, the method may further include: setting a value of the first inactivity timer to be “infinite” in response to one of the followings: performing a MBS session join procedure for at least one MBS session, or for at least one MBS session of a delivery mode with high QoS requirement, or for a multicast session; transmitting a MBS session configuration for at least one MBS session, or for at least one MBS session of a delivery mode with high QoS requirement, or for a multicast session; and performing a MBS session start procedure for at least one MBS session, or for at least one MBS session of a delivery mode with high QoS requirement, or for a multicast session.

Some embodiments of the present application also provide an apparatus, include: at least one non-transitory computer-readable medium having computer executable instructions stored therein; at least one receiving circuitry; at least one transmitting circuitry; and at least one processor coupled to the at least one non-transitory computer-readable medium, the at least one receiving circuitry and the at least one transmitting circuitry. The computer executable instructions are programmed to implement any method as stated above with the at least one receiving circuitry, the at least one transmitting circuitry and the at least one processor.

Embodiments of the present application provide a technical solution for multicast and broadcast services, which can avoid unnecessary RRC state transition, especially avoiding a UE transferring from RRC_CONNECTED state to RRC_IDLE state or RRC_INACTIVE state, thereby facilitating achieving the objectives of the multicast and broadcast services.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application;

FIG. 2 is a flow chart illustrating an exemplary procedure of a method for MBS according to some embodiments of the present application;

FIG. 3 is a flow chart illustrating an exemplary procedure of a method for MBS according to some other embodiments of the present application; and

FIG. 4 illustrates a block diagram of an exemplary apparatus for MBS according to some embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP long term evolution (LTE), and so on. It is contemplated that along with the developments of network architectures and new service scenarios, all embodiments in the present application are also applicable to similar technical problems; and moreover, the terminologies recited in the present application may be updated, which should not affect the principle of the present application.

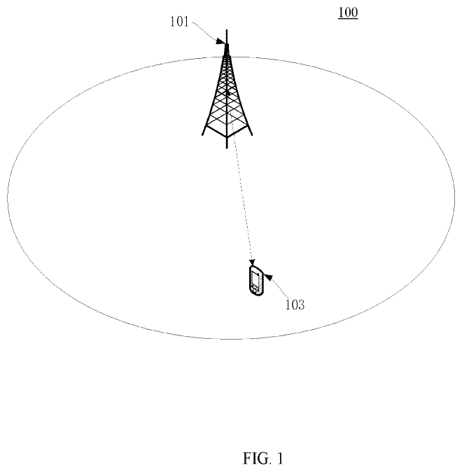

FIG. 1 illustrates a schematic diagram of an exemplary wireless communication system 100 according to some embodiments of the present application.

As shown in FIG. 1, the wireless communication system 100 includes a BS 101 and a UE 103. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In NR R17, MBS was introduced to focus on a small area mixed mode multicast. The work item on NR support of MBS was also agreed in R17 (refer to RP-201038), wherein three RRC states, i.e., RRC_IDLE state, RRC_INACTIVE state and RRC_CONNECTED state will be supported according to the following objectives:
Specify RAN basic functions for broadcast/multicast for UEs in RRC_CONNECTED state;
Specify RAN basic functions for broadcast/multicast for UEs in RRC_IDLE/RRC INACTIVE states.

Specifically, for RRC_IDLE state and RRC_INACTIVE state, NR MBS will use a LTE single carrier-PTM (SC-PTM) liked scheme. According to the LTE SC-PTM liked scheme, MCCH will carry configuration information, e.g., a 5G MBS PTM Configuration message which indicates the active 5G MBS sessions and the scheduling information for each session (or bearer). The scheduling information may include: scheduling period, scheduling window and start offset etc. The information on MCCH will be periodically transmitted using a configurable repetition period. In addition, 5G MBS user data will be carried by a multicast traffic channel (MTCH) logical channel. Usually, the MCCH configuration is provided by system information, e.g., SIB, which may contain MCCH modification period, MCCH repetition period and MCCH subframe offset. In some special situations, the MCCH configuration may be provided by other adaptable manners. In addition, for RRC_CONNECTED state and multicast services with high QoS requirement, the 5G MBS configuration information is provided to a UE by RRC dedicated signaling directly.

In RAN2 #112e meeting, two modes for NR MBS delivery are specified according to QoS requirement(s) to be available in RRC_CONNECTED state, e.g., reliability requirement, latency requirement, and so on. Specifically, one delivery mode is a delivery mode with high QoS requirement, which may be referred to as “the first delivery mode.” In the first delivery mode, the UE may always stay in RRC_CONNECTED state for data reception of MBS session(s). Another delivery mode is a delivery mode with low QoS requirement, which may be referred to as “the second delivery mode”. In the second delivery mode, a UE can also receive data in RRC_IDLE state or RRC_INACTIVE state.

In some embodiments, high QoS requirement and low QoS requirement are different for different service types, and persons skilled in the art could clearly determine the high QoS requirement and low QoS requirement in different application scenarios. For example, the high QoS requirement may mean high reliability, low latency, and etc. The low QoS requirement may mean low reliability, high latency, and etc.

When data reception or transmission in a UE is inactive, the UE may transfer from RRC_CONNECTED state to RRC_IDLE state or RRC_INACTIVE state. There are two exemplary data inactivity timers related to such a RRC state transition, i.e., dataInactivityTimer and ue-InactiveTime specified in 3GPP standard documents. When the dataInactivityTimer expires, the UE shall enter RRC_IDLE state. When the timer ue-InactiveTime expires, the network side may send the UE to RRC_IDLE state or RRC_INACTIVE state.

However, if the timers associated with data inactivity are configured and handled in an improper way, the UE may enter RRC_IDLE state or RRC_INACTIVE state unnecessarily, which may result in an interruption of data reception of the MBS session. Therefore, how to handle the data inactivity timers to avoid UE moving to the RRC_IDLE state or RRC_INACTIVE state unnecessarily when the UE is configured with an MBS session with high QoS requirement should be seriously considered.

Accordingly, embodiments of the present application provide a technical solution for MBS, which can avoid unnecessary RRC state transition of a UE, especially avoiding transition from RRC_CONNECTED state to RRC_IDLE state or the RRC_INACTIVE state. More details on embodiments of the present application will be illustrated in the following text in combination with the appended drawings.

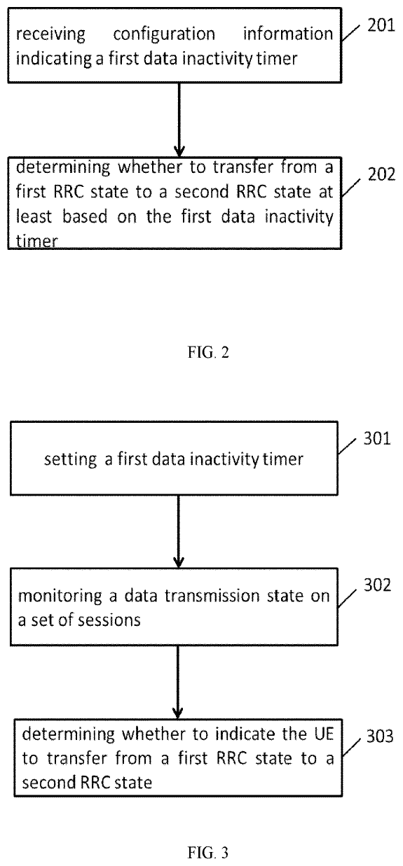

FIG. 2 is a flow chart illustrating an exemplary procedure of a method for MBS according to some embodiments of the present application. The method may be performed by a UE, for example, the UE 103 as shown in FIG. 1).

In the exemplary method shown in FIG. 2, in step 201, a UE, for example, the UE 103 may receive configuration information from a BS, for example, the BS 101. The configuration information may indicate a first data inactivity timer associated with MBS. In an embodiment of the present application, the configuration information may indicate the time length of the first data inactivity timer.

After receiving the configuration information, in step 202, the UE may determine whether to transfer from a first RRC state to a second RRC state at least based on the first data inactivity timer. The first RRC state may be one of: RRC_CONNECTED state, RRC_IDLE state, and RRC_INACTIVE state. The second RRC state is different from the first RRC state and may be one of: RRC_CONNECTED state, RRC_IDLE state, and RRC_INACTIVE state.

According to some embodiments of the present application, the UE may determine whether to transfer from the first RRC state to the second RRC state based on the first data inactivity timer and monitoring data on a set of logical channels. In this specification, the wording “a set of” means one or more.

For example, in the case that the UE receives or transmits data on at least one logical channel of the set of logical channels in the first RRC state being RRC_CONNECTED state, the UE may start or restart the first data inactivity timer. In the case that the first data inactivity timer expires, the UE may transfer to the second RRC state being RRC_IDLE state or RRC_INACTIVE state from the first RRC state. In an embodiment, the data received or transmitted on the at least one logical channel may refer to a medium access control (MAC) service data unit (SDU). In another embodiment, the first data inactivity timer may be named dataInactivityTimer as specified in 3GPP standard documents.

In some embodiments, the set of logical channels may include at least one of: a MTCH and a MCCH. The MTCH and the MCCH may be referred to as a MBS logical channel. There may be other type of MBS logical channel in the future. The MTCH may be a traffic channel used for the transmission of user plane information of MBS. That is, the MTCH is a point-to-multipoint downlink logical channel for transmitting traffic data from the network side to the UE. The MCCH may be a control channel used for transmission of control plane information of MBS. That is, the MCCH is point-to-multipoint downlink logical channel used for transmitting MBS control information from the network side to the UE. The MBS control information transmitted by the MCCH may be used for one or more MTCHs.

In some other embodiments, the set of logical channels may include at least one of: a MTCH, a MCCH, a CCCH, a DCCH, and a DTCH. The CCCH, DCCH, and DTCH may be the logical channels for unicast services of the UE. That is, to ensure the UE not to improperly transfer RRC state, the UE may also monitor data transmission on the logical channels for unicast services.

Although the same name of data inactivity timers as those in legacy standards can be used in some embodiments of the present application, the specific definition and operation associated with the concerned timers are different and novel. For example, the section “data inactivity monitoring” described in 3GPP standard document TS 38.321 and the section “UE actions upon the expiry of DataInactivityTimer” described in 3GPP standard document TS 38.331 may be updated according to some embodiments of the present application. Specifically, the above sections may be changed to the following contents or the like.

Data Inactivity Monitoring (changed based on TS 38.321)
When dataInactivityTimer is configured, the UE shall:

| 1> | if in RRC_CONNECTED state: | |
|---|---|---|
| | 2> | if any MAC entity receives a MAC SDU for DTCH logical channel, DCCH |
| | | logical channel, CCCH logical channel, MTCH logical channel, or MCCH |
| | | logical channel; or |
| | 2> | if any MAC entity transmits a MAC SDU for DTCH logical channel, DCCH |
| | | logical channel, MTCH logical channel, or MCCH logical channel; |
| | | 3> start or restart dataInactivityTimer. |
| | 2> | if the dataInactivityTimer expires: |
| | 3> | indicate the expiry of the dataInactivityTimer to upper layers. |

UE actions upon the expiry of DataInactivityTimer (changed based on TS 38.331)

| 1> | Upon receiving the expiry of DataInactivityTimer from lower layers while in | |
|---|---|---|
| | RRC_CONNECTED, the UE shall: | |
| | 2> | perform the actions upon going to RRC_IDLE with release cause ‘RRC |

connection failure’.

The above embodiments illustrate monitoring data inactivity on MTCH and/or MCCH without differentiating the delivery modes. However, as stated above, for the delivery mode with high QoS requirement, when the UE is performing data reception of an MBS session, a transition from RRC_CONNECTED state to RRC_INACTIVE state or RRC_IDLE state may result in an interruption of data reception of the MBS session. On the other hand, for the delivery mode low QoS requirement, since the UE can receive data on MBS logical channel(s) in RRC_INACTIVE state or RRC_IDLE state, it is no need to perform data inactivity monitoring on MBS logical channels of delivery mode low QoS requirement. Given this, according to some other embodiments of the present application, separate MBS logical channel (or MBS logical channel type) for two delivery modes may be defined.

In an embodiment, the MBS logical channels may be classified as MBS logical channels of a delivery mode with high QoS requirement and MBS logical channels of a delivery mode with low QoS requirement. For example, the UE may have a set of MBS logical channels associated with the MBS. The set of MBS logical channels may include: a MTCH of a delivery mode with high QoS requirement; a MCCH of a delivery mode for high QoS requirement, a MTCH of a delivery mode with low QoS requirement, and a MCCH of a delivery mode with low QoS requirement.

The MTCH of a delivery mode with high QoS requirement is a point-to-multipoint downlink logical channel for transmitting traffic data of MBS session(s) with high QoS requirement from the network side to the UE. The MCCH of a delivery mode with high QoS requirement is point-to-multipoint downlink logical channel used for transmitting MBS control information for MBS session(s) with high QoS requirement from the network side to the UE. The MTCH of a delivery mode with low QoS requirement is a point-to-multipoint downlink logical channel for transmitting traffic data of MBS session(s) with low QoS requirement from the network side to the UE. The MCCH of a delivery mode with high QoS requirement is point-to-multipoint downlink logical channel used for transmitting MBS control information for MBS session(s) with high QoS requirement from the network side to the UE.

When separate MBS logical channels in two delivery modes are defined, the UE may monitor data on a subset of the set of MBS logical channels. That is, the set of logical channels is a subset of a set of MBS logical channels. In an example, only the logical channels of the delivery mode with high QoS requirement need to be monitored. That is, the subset of the set of MBS logical channels may include at least one of: the MTCH of a delivery mode with high QoS requirement, and the MCCH of a delivery mode with high QoS requirement. In another example, the set of logical channels may include at least one of: the MTCH of a delivery mode with high QoS requirement, the MCCH of a delivery mode with high QoS requirement, the CCCH, the DCCH, and the DTCH.

In another embodiment, the MBS logical channels may be classified as MBS logical channels for multicast session(s) and MBS logical channels for broadcast session(s). In some embodiments, a multicast session may be a session with high QoS requirement and the broadcast session may be a session with low QoS requirement. For example, the UE may have a set of MBS logical channels associated with the MBS. The set of MBS logical channels may include: a traffic channel for a multicast session, a control channel for a multicast session, a traffic channel for a broadcast session, and a control channel for a broadcast session.

The traffic channel for a multicast session is a point-to-multipoint downlink logical channel for transmitting traffic data of multicast session(s) from the network side to the UE. The control channel for a multicast session is point-to-multipoint downlink logical channel used for transmitting MBS control information for multicast session(s) from the network side to the UE. The traffic channel for a broadcast session is a point-to-multipoint downlink logical channel for transmitting traffic data of broadcast session(s) from the network side to the UE. The control channel for a broadcast session is point-to-multipoint downlink logical channel used for transmitting MBS control information for broadcast session(s) from the network side to the UE.

When the MBS logical channels are classified as MBS logical channels for multicast session(s) and MBS logical channels for broadcast session(s), the UE may monitor data on a subset of the set of MBS logical channels. That is, the set of logical channels is a subset of a set of MBS logical channels. In an example, the multicast session may have high QoS requirement, and thus only the logical channels for the multicast session need to be monitored. That is, the subset of the set of MBS logical channels may include at least one of: the traffic channel for a multicast session, and the control channel for a multicast session. In another example, the set of logical channels may include at least one of: the traffic channel for a multicast session, the control channel for a multicast session, the CCCH, the DCCH, and the DTCH.

Similarly, although the same name of data inactivity timers as those in legacy standards can be used in some embodiments of the present application, the specific definition and operation associated with the concerned timers are different and novel. For example, according to above embodiments of the present application, when the two delivery modes are introduced, the section “data inactivity monitoring” described in 3GPP standard document TS 38.321 and the section “UE actions upon the expiry of DataInactivityTimer” described in 3GPP standard document TS 38.331 may be updated. Specifically, the above sections may be changed to the following contents or the like.

Data Inactivity Monitoring (changed based on TS 38.321)
When dataInactivityTimer is configured, the UE shall:

| 1> | if in RRC_CONNECTED state: | |
|---|---|---|
| | 2> | if any MAC entity receives a MAC SDU for DTCH logical channel, DCCH |
| | | logical channel, CCCH logical channel, MTCH logical channel of a delivery |
| | | mode with high QoS requirement (or a traffic channel for a multicast |
| | | session), or MCCH logical channel a delivery mode with high QoS |
| | | requirement (or a control channel for a multicast session); or |
| | 2> | if any MAC entity transmits a MAC SDU for DTCH logical channel, DCCH |
| | | logical channel, MTCH logical channel of a delivery mode with high QoS |
| | | requirement (or a traffic channel for a multicast session), or MCCH logical |
| | | channel a delivery mode with high QoS requirement (or a control channel for a |
| | | multicast session); |
| | | 3> start or restart dataInactivityTimer. |
| | 2> | if the dataInactivityTimer expires: |
| | 3> | indicate the expiry of the dataInactivityTimer to upper layers. |

UE actions upon the expiry of DataInactivityTimer (changed based on TS 38.331)

| 1> | Upon receiving the expiry of DataInactivityTimer from lower layers while in | |
|---|---|---|
| | RRC_CONNECTED, the UE shall: | |
| | 2> | perform the actions upon going to RRC_IDLE with release cause ‘RRC |
| | | connection failure’. |

According to some other embodiments of the present application, two separate data inactivity timers may be defined for MBS logical channel(s) and for unicast logical channel(s). In addition to the first data inactivity timer associated with the MBS, the configuration information may further indicate a second data inactivity timer associated with unicast services. In an embodiment of the present application, the configuration information may indicate the time length of the second data inactivity timer.

In the case of receiving or transmitting data on at least one MBS logical channel in the first RRC state being RRC_CONNECTED state, the UE may start or restart the first data inactivity timer. In the case of receiving or transmitting data on at least one unicast logical channel of the set of logical channels, the UE may start or restart the second data inactivity timer. In the case that both the first data inactivity timer and the second data inactivity timer expire, the UE may transfer to the second RRC state being RRC_IDLE state or RRC_INACTIVE state from the first RRC state. In an embodiment of the present application, the data being transmitted or received on the at least one unicast logical channel may be a MAC SDU. In an embodiment of the present application, the first data inactivity timer may be a new timer named dataInactivityTimerOfMBS only for the MBS and the second data inactivity timer may be named dataInactivityTimer as specified in 3GPP standard documents.

The at least one MBS logical channel may be at least one of a MTCH and a MCCH, or at least one of a MTCH of a delivery mode with high QoS requirement and a MCCH of a delivery mode with high QoS requirement, or at least one of a traffic channel for a multicast session and a control channel for a multicast session. The at least one unicast logical channel is at least one of a CCCH, a DCCH, and a DTCH.

Similarly, when two separate data inactivity timers are defined for MBS logical channel(s) and for unicast logical channel(s), according to some embodiments of the present application, the section “data inactivity monitoring” described in 3GPP standard document TS 38.321 and the section “UE actions upon the expiry of DataInactivityTimer” described in 3GPP standard document TS 38.331 may be updated. For example, the above sections may be changed to the following contents or the like.

Data Inactivity Monitoring (changed based on TS 38.321)
When dataInactivityTimer is configured, the UE shall:

| 1> | if in RRC_CONNECTED state: | |
|---|---|---|
| | 2> | if any MAC entity receives a MAC SDU for DTCH logical channel, DCCH |
| | | logical channel, CCCH logical channel; or |
| | 2> | if any MAC entity transmits a MAC SDU for DTCH logical channel, DCCH |
| | | logical channel; |
| | | 3> start or restart dataInactivityTimer. |
| | 2> | if the dataInactivityTimer expires: |
| | 3> | indicate the expiry of the dataInactivityTimer to upper layers. |

Data Inactivity Monitoring (changed based on TS 38.321)
When dataInactivityTimerOfMBS is configured, the UE shall:

| 1> | if in RRC_CONNECTED state: | |
|---|---|---|
| | 2> | if any MAC entity receives a MAC SDU for (MTCH logical channel or |
| | | MCCH logical channel), or (MTCH logical channel of a delivery mode with |
| | | high QoS requirement or MCCH logical channel a delivery mode with high |
| | | QoS requirement) or (a traffic channel for a multicast session or a control |
| | | channel for a multicast session); or |
| | 2> | if any MAC entity transmits a MAC SDU for (MTCH logical channel or |
| | | MCCH logical channel), or (MTCH logical channel of a delivery mode with |
| | | high QoS requirement or MCCH logical channel a delivery mode with high |
| | | QOS requirement) or (a traffic channel for a multicast session or a control |
| | | channel for a multicast session); |
| | | 3> start or restart dataInactivityTimerOfMBS. |
| | 2> | if the dataInactivityTimerOfMBS expires: |
| | 3> | indicate the expiry of the dataInactivityTimerOfMBS to upper layers. |

UE actions upon the expiry of both DataInactivityTimer and
dataInactivityTimerOfMBS (changed based on TS 38.331)

| 1> | Upon receiving the expiry of both DataInactivityTimer and | |
|---|---|---|
| | dataInactivityTimerOfMBS from lower layers while in RRC_CONNECTED, the | |
| | UE shall: | |
| | 2> | perform the actions upon going to RRC_IDLE with release cause ‘RRC |
| | | connection failure’. |

According to some embodiments of the present application, after receiving the configuration information indicating the first data inactivity timer, the UE may deactivate or suspend the first data inactivity timer in response to performing a MBS session join procedure for at least one MBS session, or for at least one MBS session of a delivery mode with high QoS requirement, or for a multicast session. In some embodiments of the present application, after receiving the configuration information indicating the first data inactivity timer, the UE may deactivate or suspend the first data inactivity timer in response to receiving a MBS session configuration for at least one MBS session, or for at least one MBS session of a delivery mode with high QoS requirement, or for a multicast session. In some other embodiments of the present application, after receiving the configuration information indicating the first data inactivity timer, the UE may deactivate or suspend the first data inactivity timer in response to performing a MBS session start procedure for at least one MBS session, or for at least one MBS session of a delivery mode with high QoS requirement, or for a multicast session. In an embodiment of the present application, the first data inactivity timer may be named dataInactivityTimer as specified in 3GPP standard documents or a new timer named dataInactivityTimerOfMBS or the like defined only for MB S.

The session join procedure may be used by the UE to inform the network side that the UE is interested in receiving an MBS session or may mean that the UE joins the multicast group. The session start procedure may be used by the network side to activate an MBS session and start transmission of multicast/broadcast data. During the session start procedure, resources for the MBS session are setup.

According to some other embodiments of the present application, after receiving the configuration information indicating the first data inactivity timer, the UE may activate or resume the first data inactivity timer in response to performing a MBS session leave procedure for all MBS sessions, or for all MBS sessions of a delivery mode with high QoS requirement, or for all multicast sessions. In some other embodiments of the present application, after receiving the configuration information indicating the first data inactivity timer, the UE may activate or resume the first data inactivity timer in response to performing a MBS session stop (or release) procedure for all MBS sessions, or for all MBS sessions of a delivery mode with high QoS requirement, or for all multicast sessions. In an embodiment of the present application, the first data inactivity timer may be named dataInactivityTimer as specified in 3GPP standard documents or a new timer named dataInactivityTimerOfMBS or the like defined only for MBS.

According to some embodiments of the present application, the following contents or the like may be added to 3GPP standard documents to further illustrate the activation/resuming and deactivation/suspending of the first data inactivity timer by a UE autonomously.

When first data inactivity timer (e.g., dataInactivityTimer or
dataInactivityTimerOfMBS) is configured, the UE shall:

| | |
|---|---|
| 1> | when UE performs a MBS session join procedure for at least one MBS session, |
| | or for at least one MBS session of a delivery mode with high QoS requirement, |
| | or for a multicast session, or when UE receives a MBS session configuration for |
| | at least one MBS session, or for at least one MBS session of a delivery mode |
| | with high QoS requirement, or for a multicast session, or when UE performs a |
| | MBS session start procedure for at least one MBS session, or for at least one |
| | MBS session of a delivery mode with high QoS requirement, or for a multicast |
| | session. |
| | 2> deactivates or suspends the first data inactivity timer. |
| 1> | when UE performs a MBS session leave procedure for all MBS sessions, or for |
| | all MBS sessions of a delivery mode with high quality of service (QoS) |
| | requirement, or for all multicast sessions, or when UE performs a MBS session |
| | stop procedure for all MBS sessions, or for all MBS sessions of a delivery mode |
| | with high QoS requirement, or for all multicast sessions, or when UE leaves all |
| | MBS sessions, or all MBS sessions of a delivery mode with high QoS |
| | requirement, or all multicast sessions, or when all MBS sessions, or all MBS |
| | sessions of a delivery mode with high QoS requirement, or all multicast |
| | sessions are stopped. |
| | 2> activates or resumes the first data inactivity timer. |

According to some other embodiments, after receiving the configuration information indicating the first data inactivity timer, the UE may deactivate or suspend the first data inactivity timer in response to a signalling received from the BS. The received signalling may indicate one of the followings: a data inactivity monitoring indication, a timer deactivation indication, and a timer suspension command. In an embodiment of the present application, the first data inactivity timer may be named dataInactivityTimer as specified in 3GPP standard documents or a new timer named dataInactivityTimerOfMBS or the like defined only for MBS.

According to some other embodiments of the present application, after receiving the configuration information indicating the first data inactivity timer, the UE may activate or resume the first data inactivity timer in response to a signalling received from the BS. The received signalling may indicate one of the followings: a data inactivity monitoring indication, a timer activation indication, and a timer resumption command. In an embodiment of the present application, the first data inactivity timer may be named dataInactivityTimer as specified in 3GPP standard documents or a new timer named dataInactivityTimerOfMBS or the like defined only for MBS.

In an embodiment of the present application, the received signalling may be one of the following: a RRC signaling, a MAC CE, and DCI in a PDCCH.

According to embodiments of the present application, the following contents or the like may be added to 3GPP standard documents to further illustrate the activation/resuming and deactivation/suspending of the first data inactivity timer in response to a signalling from the BS.

When first data inactivity timer (e.g., dataInactivityTimer or
dataInactivityTimerOfMBS) is configured, the UE shall:

| | |
|---|---|
| 1> | when UE receives a data inactivity monitoring indication, or a timer |
| | deactivation indication, or a timer suspension command. |
| | 2> deactivates or suspends the first data inactivity timer. |
| 1> | when UE receives a data inactivity monitoring indication, or a timer activation |
| | indication, or a timer resumption command. |
| | 2> activates or resumes the first data inactivity timer. |

According to some other embodiments of the present application, in the case that the first data inactivity timer expires, instead of going to RRC_IDLE state or RRC_INACTIVE state directly, the UE may transmit a first indication to indicate the expiry of the first data inactivity timer to the BS when the UE is in the first RRC state being RRC_CONNECTED state or the UE may request the RRC release by transmitting a RRC release request message to the BS. For example, the first indication may be a data inactivity timer expiry indication or a cause value. In an embodiment of the present application, the first indication may be included in a RRC release request message or in a UE assistance information message as specified in 3GPP standard documents.

After receiving the first indication, the BS may decide whether to indicate the UE to transfer to the RRC_IDLE state or RRC_INACTIVE state. Then, the BS may transmit a second indication indicating whether to transfer from the first RRC state to the second RRC state being RRC_IDLE state or RRC_INACTIVE state to the UE. In an embodiment, the second indication may be a RRC release message.

For example, if a MBS session, or a MBS session of a delivery mode with high QoS requirement, or a multicast session has not been leaved or stopped for the UE, the network side will not indicate the UE to transfer to the RRC_IDLE state or RRC_INACTIVE state. In this case, the second indication may be a RRC release reject message. After receiving the second indication, the UE may stay at the RRC_CONNECTED state, and not transfer to the RRC_IDLE state or RRC_INACTIVE state.

In an embodiment of the present application, the first indication may be transmitted based on some conditions. For example, in the case that the first data inactivity timer expires and there is available MBS context for a MBS session or available MBS context for a MBS session of a delivery mode with QoS requirement or available MBS context for a multicast session, the UE may transmit the first indication to indicate the expiry of the first data inactivity timer to the BS.

After receiving the first indication, the BS may decide whether to indicate the UE to transfer to RRC_IDLE state or RRC_INACTIVE state. Then, the BS may transmit a second indication indicating whether to transfer from the first RRC state to the second RRC state being RRC_IDLE state or RRC_INACTIVE state to the UE. In an embodiment, the second indication may be a RRC release message.

Since the second indication is transmitted in the case that the available MBS context exists, the second indication may indicate the UE not to transfer to RRC_IDLE state or RRC_INACTIVE state. After receiving the second indication, the UE may stay at RRC_CONNECTED state, and not transfer to RRC_IDLE state or RRC_INACTIVE state to the UE.

According to some embodiments of the present application, the UE may avoid moving to RRC_IDLE state or RRC_INACTIVE by setting the value of the first data inactivity timer as “infinite.” In an embodiment of the present application, the first data inactivity timer may be named dataInactivityTimer as specified in 3GPP standard documents or a new timer named dataInactivityTimerOfMBS or the like defined only for MBS.

In an embodiment of the present application, the BS may configure the value of the first data inactivity timer as “infinite” for the UE with a MBS session, or a MBS session a delivery mode with high QoS requirement, or a multicast session. That is, the configuration information may indicate that the first data inactivity timer has a value of “infinite.” After receiving the configuration information, the UE may set the value of the first data inactivity timer to be “infinite” or deactivate the the first data inactivity timer such that the first data inactivity timer will never expire. Therefore, the UE may not go to RRC_IDLE state or RRC_INACTIVE due to the expiry of the first data inactivity timer.

In an embodiment of the present application, the UE itself may set a value of the first data inactivity timer to be “infinite” in response to performing a MBS session join procedure for at least one MBS session, or for at least one MBS session of a delivery mode with high QoS requirement, or for a multicast session. In another embodiment of the present application, the UE itself may set a value of the first data inactivity timer to be “infinite” in response to receiving a MBS session configuration for at least one MBS session, or for at least one MBS session of a delivery mode with high QoS requirement, or for a multicast session. In yet another embodiment of the present application, the UE itself may set a value of the first data inactivity timer to be “infinite” in response to performing a MBS session start procedure for at least one MBS session, or for at least one MBS session of a delivery mode with high QoS requirement, or for a multicast session.

Similarly, since the first data inactivity timer will never expire, the UE may not go to RRC_IDLE state or RRC_INACTIVE due to the expiry of the first data inactivity timer.

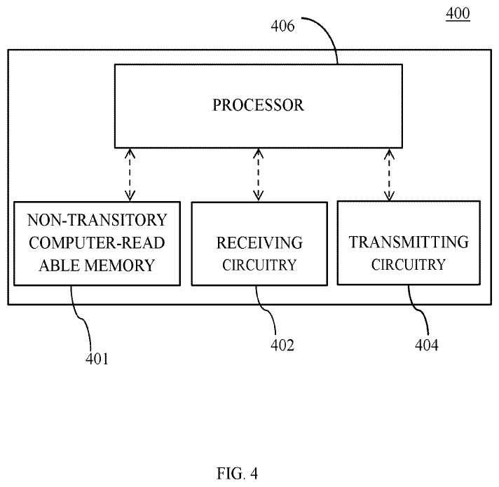

FIG. 3 is a flow chart illustrating an exemplary procedure of a method for MBS according to some other embodiments of the present application. The method may be performed by a BS (for example, the BS 101 as shown in FIG. 1).

In the exemplary method shown in FIG. 3, in step 301, a BS (for example, the BS 101) may set (or start) a first inactivity timer associated with MBS for a UE (for example, the UE 103). The first inactivity timer has a time length.

In step 302, the BS may monitor a data transmission state on a set of sessions associated with the UE in a first RRC state. The first RRC state may be one of: RRC_CONNECTED state, RRC_IDLE state, and RRC_INACTIVE state.

In step 303, the BS may determine whether to indicate the UE to transfer from a first RRC state to a second RRC state based on the first inactivity timer and the monitoring. The second RRC state is different from the first RRC state and may be one of: RRC_CONNECTED state, RRC_IDLE state, and RRC_INACTIVE state.

According to some embodiments of the present application, the set of sessions may include at least one MBS session of the UE, or at least one MBS session of a delivery mode with high QoS requirement of the UE, or at least one multicast session of the UE. In an embodiment of the present application, in addition to at least one MBS session of the UE, or at least one MBS session of a delivery mode with high QoS requirement of the UE, or at least one multicast session of the UE, the set of sessions may also include at least one unicast session (e.g., protocol data unit (PDU) session) of the UE. In an embodiment of the present application, the first inactivity timer may be named ue-Inactive Time as specified in 3GPP standard documents.

The BS may monitor data transmission state on the set of sessions during the running of first inactivity timer. For example, the first inactivity timer may be started or restarted in the case that any use data for at least one session of the set of sessions is received. In the case that the first inactivity timer expires, the BS may indicate the UE to transfer from the first RRC state being RRC_CONNECTED state to the second RRC state being RRC_IDLE state or RRC_INACTIVE state, and indicate a MBS related UE inactivity to a core network.

According to some other embodiments of the present application, the set of sessions may include at least one MBS session of the UE, or at least one MBS session of a delivery mode with high QoS requirement of the UE, or at least one multicast session of the UE. The BS may also set a second inactivity timer associated with unicast sessions (e.g. PDU sessions) for the UE. For example, the second inactivity timer may be named ue-Inactive Time as specified in 3GPP standard documents while the first inactivity timer may be a new timer named as “ueInactiveTimeOfMBS” or the like only for the MBS sessions.

The UE may monitor data transmission state on the set of sessions during the running of first inactivity timer and monitor data transmission state on at least one unicast session. For example, the first inactivity timer may be started or restarted in the case that any user data for at least one session of the set of sessions is received. The second inactivity timer may be started or restarted in the case that any user data for at least one unicast session is received.

In the case that both the first inactivity timer and the second inactivity timer expire, the BS may indicate the UE to transfer from the first RRC state being RRC_CONNECTED state to the second RRC state being RRC_IDLE state or RRC_INACTIVE state, and indicate a MBS related UE inactivity to a core network

In an embodiment, indicating the UE to transfer from the first RRC state to the second RRC state may include initiating the UE context release and corresponding RRC Release in the radio access network (RAN).

In another embodiment, indicating a MBS related UE inactivity to a core network may include transmitting a next generation application protocol (NG AP) UE context release request (or cause) message indicating “cause” to the mobility management function (AMF). The “cause” in the message may set as “User Inactivity” and the “User Inactivity” may be further set as the following table.

| | |
|---|---|
| User inactivity | The action is requested due to user inactivity on all |
| | PDU sessions and MBS Sessions, e.g., NG is |
| | requested to be released in order to optimise the |
| | radio resources. |

According to some embodiments of the present application, the BS may deactivate or suspend the first data inactivity timer in response to performing a MBS session join procedure for at least one MBS session, or for at least one MBS session of a delivery mode with high QoS requirement, or for a multicast session associated with the UE. In some other embodiments of the present application, the BS may deactivate or suspend the first data inactivity timer in response to transmitting a MBS session configuration for at least one MBS session, or for at least one MBS session of a delivery mode with high QoS requirement, or for a multicast session to the UE. In some yet other embodiments of the present application, the BS may deactivate or suspend the first data inactivity timer in response to performing a MBS session start procedure for at least one MBS session, or for at least one MBS session of a delivery mode with high QoS requirement, or for a multicast session associated with the UE. In an embodiment of the present application, the first data inactivity timer may be named ue-InactiveTime as specified in 3GPP standard documents or a new timer named ueInactiveTimegMBS or the like defined only for MBS.

According to some embodiments of the present application, the BS may activate or resume the first data inactivity timer in response to performing a MBS session leave procedure for all MBS sessions, or for all MBS sessions of a delivery mode with high QoS requirement, or for all multicast sessions associated with the UE. In some other embodiments of the present application, the BS may activate or resume the first data inactivity timer in response to performing a MBS session stop (or release) procedure for all MBS sessions, or for all MBS sessions of a delivery mode with high QoS requirement, or for all multicast sessions associated with the UE. In an embodiment of the present application, the first data inactivity timer may be named ue-InactiveTime as specified in 3GPP standard documents or a new timer named ueInactiveTimegMBS or the like defined only for MBS.

According to some other embodiments of the present application, the BS may set the value of the first data inactivity timer as “infinite” for the UE with a MBS session, or a MBS session a delivery mode with high QoS requirement, or a multicast session. Since the first data inactivity timer will never expire, the BS may not indicate the UE to transfer to RRC_IDLE state or RRC_INACTIVE due to the expiry of the first data inactivity timer.

According to some embodiments of the present application, the BS may set a value of the first data inactivity timer to be “infinite” in response to performing a MBS session join procedure for at least one MBS session, or for at least one MBS session of a delivery mode with high QoS requirement, or for a multicast session. According to some other embodiments of the present application, the BS may set a value of the first data inactivity timer to be “infinite” in response to receiving a MBS session configuration for at least one MBS session, or for at least one MBS session of a delivery mode with high QoS requirement, or for a multicast session associated with the UE. According to some yet other embodiments of the present application, the BS may set a value of the first data inactivity timer to be “infinite” in response to performing a MBS session start procedure for at least one MBS session, or for at least one MBS session of a delivery mode with high QoS requirement, or for a multicast session associated with the UE. Similarly, since the first data inactivity timer will never expire, the BS may not indicate the UE to transfer to RRC_IDLE state or RRC_INACTIVE due to the expiry of the first data inactivity timer.

Embodiments of the present application also propose an apparatus for MBS. For example, FIG. 4 illustrates a block diagram of an apparatus 400 for MBS according to some embodiments of the present application.

As shown in FIG. 4, the apparatus 400 may include at least one non-transitory computer-readable medium 401, at least one receiving circuitry 402, at least one transmitting circuitry 404, and at least one processor 406 coupled to the non-transitory computer-readable medium 401, the receiving circuitry 402 and the transmitting circuitry 404. The apparatus 400 may be a network side apparatus (e.g., a BS) configured to perform a method illustrated in FIG. 3, or the like, or a remote unit (e.g., a UE) configured to perform a method illustrated in FIG. 2, or the like.

Although in this figure, elements such as the at least one processor 406, transmitting circuitry 404, and receiving circuitry 402 are described in the singular, the plural is contemplated unless a limitation to the singular is explicitly stated. In some embodiments of the present application, the receiving circuitry 402 and the transmitting circuitry 404 can be combined into a single device, such as a transceiver. In certain embodiments of the present application, the apparatus 400 may further include an input device, a memory, and/or other components.

For example, in some embodiments of the present application, the non-transitory computer-readable medium 401 may have stored thereon computer-executable instructions to cause a processor to implement the method with respect to the UE as described above. For example, the computer-executable instructions, when executed, cause the processor 406 interacting with receiving circuitry 402 and transmitting circuitry 404, so as to perform the steps with respect to the UE depicted in FIG. 2.

In some embodiments of the present application, the non-transitory computer-readable medium 401 may have stored thereon computer-executable instructions to cause a processor to implement the method with respect to the BS as described above. For example, the computer-executable instructions, when executed, cause the processor 406 interacting with receiving circuitry 402 and transmitting circuitry 404, so as to perform the steps with respect to the BS depicted in FIG. 3.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for MBS, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, relational terms such as “first,” “second,” and the like may be used solely to distinguish one entity or action from another entity or action without necessarily requiring or implying any actual such relationship or order between such entities or actions. The terms “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

1. A method, comprising:
receiving configuration information indicating a first data inactivity timer associated with multicast and broadcast services (MBS); and
determining whether to transfer from a first radio resource control (RRC) state to a second RRC state at least based on the first data inactivity timer.

2. The method of claim 1, further comprising:
in a case of receiving or transmitting data on at least one logical channel of a set of logical channels in the first RRC state being RRC_CONNECTED state, starting or restarting the first data inactivity timer; and
in a case that the first data inactivity timer expires, transferring to the second RRC state being RRC_IDLE state or RRC_INACTIVE state from the first RRC state.

3. The method of claim 2, wherein the set of logical channels comprises at least one of:
a multicast traffic channel (MTCH); and
a multicast control channel (MCCH).

4. The method of claim 2, wherein the set of logical channels is a subset of a set of MBS logical channels, and the set of MBS logical channels comprises:
a multicast traffic channel (MTCH) of a delivery mode with high quality of service (QoS) requirement;
a multicast control channel (MCCH) of a delivery mode with high QoS requirement;
a MTCH of a delivery mode with low QoS requirement; and
a MCCH of a delivery mode with low QoS requirement.

5. (canceled)

6. The method of claim 2, wherein the set of logical channels is a subset of a set of MBS logical channels, and the set of MBS logical channels comprises:
a traffic channel for a multicast session;
a control channel for a multicast session;
a traffic channel for a broadcast session; and
a control channel for a broadcast session.

7. (canceled)

8. (canceled)

9. (canceled)

10. (canceled)

11. The method of claim 1, further comprising:
in a case that the first data inactivity timer expires, transmitting a first indication to indicate expiry of the first data inactivity timer in the first RRC state being RRC_CONNECTED; and
receiving a second indication indicating whether to transfer from the first RRC state to the second RRC state being RRC_IDLE state or RRC_INACTIVE state.

12. (canceled)

13. An apparatus, comprising:
a receiving circuitry;
a transmitting circuitry; and
a processor coupled to the receiving circuitry and the transmitting circuitry configured to cause the apparatus to:
set a first inactivity timer associated with multicast and broadcast services (MBS) for a user equipment (UE);
monitor a data transmission state on a set of sessions associated with the UE in a first radio resource control (RRC) state; and
determine whether to indicate the UE to transfer from a first RRC state to a second RRC state based on the first inactivity timer and the monitoring.

14. The apparatus of claim 13, wherein the processor is configured to cause the apparatus to:
in a case that the first inactivity timer expires:
indicate to the UE to transfer from the first RRC state being RRC_CONNECTED state to the second RRC state being RRC_IDLE state or RRC_INACTIVE state; and
indicate a MBS related UE inactivity to a core network.

15. An apparatus, comprising:
a receiving circuitry;
a transmitting circuitry; and
a processor coupled to the receiving circuitry and the transmitting circuitry configured to cause the apparatus to:
receive configuration information indicating a first data inactivity timer associated with multicast and broadcast services (MBS); and
determine whether to transfer from a first radio resource control (RRC) state to a second RRC state at least based on the first data inactivity timer.

16. The apparatus of claim 15, wherein the processor is configured to cause the apparatus to:
in a case of receiving or transmitting data on at least one logical channel of a set of logical channels in the first RRC state being RRC_CONNECTED state, start or restart the first data inactivity timer; and
in a case that the first data inactivity timer expires, transfer to the second RRC state being RRC_IDLE state or RRC_INACTIVE state from the first RRC state.

17. The apparatus of claim 16, wherein the set of logical channels comprises at least one of:
a multicast traffic channel (MTCH); and
a multicast control channel (MCCH).

18. The apparatus of claim 16, wherein the set of logical channels is a subset of a set of MBS logical channels, and the set of MBS logical channels comprises:
a multicast traffic channel (MTCH) of a delivery mode with high quality of service (QoS) requirement;
a multicast control channel (MCCH) of a delivery mode with high QoS requirement;
a MTCH of a delivery mode with low QoS requirement; and
a MCCH of a delivery mode with low QoS requirement.

19. The apparatus of claim 18, wherein the subset of the set of MBS logical channels comprises at least one of:
the MTCH of a delivery mode with high QoS requirement;
the MCCH of a delivery mode with high QoS requirement.

20. The apparatus of claim 16, wherein the set of logical channels is a subset of a set of MBS logical channels, and the set of MBS logical channels comprises:
a traffic channel for a multicast session;
a control channel for a multicast session;
a traffic channel for a broadcast session; and
a control channel for a broadcast session.

21. The apparatus of claim 20, wherein the subset of the set of MBS logical channel comprises at least one of:
the traffic channel for a multicast session; and
the control channel for a multicast session.

22. The apparatus of claim 15, wherein the configuration information further indicates a second data inactivity timer associated with unicast services, and the processor is configured to cause the apparatus to:
in a case of receiving or transmitting data on at least one MBS logical channel in the first RRC state being RRC_CONNECTED state, start or restart the first data inactivity timer;
in a case of receiving or transmitting data on at least one unicast logical channel, start or restart the second data inactivity timer; and
in a case that both the first data inactivity timer and the second data inactivity timer expire, transfer to the second RRC state being RRC_IDLE state or RRC_INACTIVE state from the first RRC state.

23. The apparatus of claim 15, wherein the processor is configured to cause the apparatus to:
deactivate or suspend the first data inactivity timer in response to one of:
performing a MBS session join procedure for at least one MBS session, or for at least one MBS session of a delivery mode with high quality of service (QoS) requirement, or for a multicast session;
receiving a MBS session configuration for at least one MBS session, or for at least one MBS session of a delivery mode with high QoS requirement, or for a multicast session; and
performing a MBS session start procedure for at least one MBS session, or for at least one MBS session of a delivery mode with high QoS requirement, or for a multicast session.

24. The apparatus of claim 15, wherein the processor is configured to cause the apparatus to:
deactivate or suspend the first data inactivity timer in response to a received signaling indicating one of:
a data inactivity monitoring indication;
a timer deactivation indication; and
a timer suspension command.

25. The apparatus of claim 15, wherein the processor is configured to cause the apparatus to:
in a case that the first data inactivity timer expires, transmit a first indication to indicate expiry of the first data inactivity timer in the first RRC state being RRC_CONNECTED; and
receive a second indication indicating whether to transfer from the first RRC state to the second RRC state being RRC_IDLE state or RRC_INACTIVE state.

26. The apparatus of claim 15, wherein the processor is configured to cause the apparatus to:
set a value of the first data inactivity timer to be infinite in response to one of:
performing a MBS session join procedure for at least one MBS session, or for at least one MBS session of a delivery mode with high quality of service (QoS) requirement, or for a multicast session;
receiving a MBS session configuration for at least one MBS session, or for at least one MBS session of a delivery mode with high QoS requirement, or for a multicast session; and
performing a MBS session start procedure for at least one MBS session, or for at least one MBS session of a delivery mode with high QoS requirement, or for a multicast session.
